(19) United States
(12) Patent Application Publication
(10) Pub. No.: US 2017/0111983 A1
(43) Pub. Date: Apr. 20, 2017

(54) A CONTROLLER FOR A LIGHT SYSTEM

(71) Applicant: TOLWONG TRADING PTY LIMITED, New South Wales (AU)

(72) Inventor: Peter MCCONAGHY, New South Wales (AU)

(21) Appl. No.: 15/311,608

(22) PCT Filed: May 19, 2015
(86) PCT No.: PCT/AU2015/050253

§ 371 Date: Nov. 16, 2016

(30) Foreign Application Priority Data
May 19, 2014 (AU) 2014901865

(51) Int. Cl. H05B 37/02; H05B 33/08

(52) U.S. Cl. CPC H05B 37/0281; H05B 37/0227; H05B 33/0809

(57) ABSTRACT

Disclosed herein is a controller for a bathroom light system. The controller comprises a timer which is adapted to receive a signal that starts a timing interval, and an electricity supply controller which causes power supplied to a bathroom light system to be reduced when the timing interval ends, but which ensures that the bathroom light system still provides a source of light. Also disclosed herein is a method for reducing energy consumption by a bathroom light system.

### TECHNICAL FIELD

The present invention relates to electrical controllers and, in particular, to controllers for bathroom light systems.

### BACKGROUND ART

Many light systems include components which draw relatively large amounts of power. For example, it is now common for bathrooms to have lighting systems which include a number of heat lamps, an exhaust fan and a less power-intensive light source (e.g. a typical incandescent light or a LED light). In order to save power, it is usually possible to operate each of these components separately. For example, a person entering a bathroom merely to brush their teeth may only require the normal light source (or only one of the heat lamps) of the bathroom light system to be switched on.

In the event that such bathroom light systems (and especially the power intensive components of such systems) are inadvertently left on, however, a significant amount of power can be wasted. It would be advantageous to lessen the amount of power consumed in the event of a user not correctly turning off the bathroom light system.

### SUMMARY OF INVENTION

In a first aspect, the present invention provides a bathroom light system controller. The controller comprises a timer which is adapted to receive a signal that starts a timing interval, and an electricity supply controller which causes power supplied to a bathroom light system to be reduced when the timing interval ends, but which ensures that the bathroom light system still provides a source of light.

The present invention advantageously provides a bathroom light system controller which can save power in the event that the bathroom light system (or a component of the bathroom light system) is inadvertently left on, but which ensures that, in doing so, there is no risk that a person might inadvertently be left in the dark. Systems in which all sources of light are turned off after a specific time (even if this time was selected by a user) can result in potentially dangerous situations. For example, bathrooms in apartments often do not have external sources of light, and automatically turning off all sources of light after a predefined period of time runs the risk of leaving a user of the bathroom in a pitch dark environment. Injury may ensue should the person accidentally trip over something whilst making their way to the door of the bathroom in the dark.

In some embodiments, the electricity supply controller is adapted to control the amount of power received by a component (e.g. one that draws a substantial proportion of the total power required by the bathroom light system) of the bathroom light system. Thus, the controller can reduce the amount of power supplied to the component (e.g. by “dimming” heat lamps or turning them off completely if another source of light in the light system is also turned on) to reduce the system's overall power consumption, but whilst ensuring that at least some light is still provided.

In some embodiments, the electricity supply controller is adapted to reduce the power supply to the bathroom light system by turning off a primary light source of the bathroom light system (e.g. one or more heat lamps), whilst ensuring that a secondary light source of the bathroom light system (e.g. the normal light) is turned on.

In some embodiments, the signal that starts the timing interval is caused by the bathroom light system being switched on. In some embodiments, the signal that starts the timing interval is caused by a component which draws a substantial proportion of the total power required by the bathroom light system (e.g. the heat lamp(s)) being switched on. For example, the amount of power used by the normal light in a bathroom lighting system may not warrant it being automatically turned off (or dimmed) via the present invention. Indeed, in some circumstances, a user may even want to leave the normal light on for a longer time period (e.g. overnight) and therefore not require it to be automatically turned off. In such cases, turning on the normal light should not produce the signal that starts the timing interval.

In some embodiments, the controller further comprises a detector adapted to provide a signal that resets the timing interval upon detection of conditions indicative of a person being in the bathroom. That is, once the bathroom light system is switched on, the presence of a person in the vicinity of the detector (and light system) will act to reset the timer and delay the controller reducing the power supplied to the light system.

In a second aspect, the present invention provides a bathroom light system comprising the bathroom light system controller of the first aspect.

In a third aspect, the present invention provides a method for reducing energy consumption by a bathroom light system. The method comprises starting a timing interval upon receipt of a signal and, when the timing interval finishes, reducing power to the bathroom light system, but whilst ensuring that the bathroom light system still provides a source of light.

In some embodiments, the signal is caused by the bathroom light system being switched on. In some embodiments, the signal is caused by a component which draws a substantial proportion of the total power required by the bathroom light system being switched on.

In some embodiments, power to the bathroom light system may be reduced by turning off a component of the bathroom light system which draws a substantial proportion of the total power required by the light system (provided that doing so would not leave a person in the bathroom without light). In some embodiments, power to the bathroom light system may be reduced by reducing the amount of power supplied to a component of the bathroom light system which draws a substantial proportion of the total power required by the light system.

In some embodiments, power to the bathroom light system may be reduced by turning off a primary light source of the light system and ensuring that a secondary light source of the light system is turned on. In some embodiments, ensuring that the secondary light source is turned on may comprise determining (e.g. by measuring a current flowing through the secondary light source) to see whether the secondary light source is turned on and, if not, turning it on.

In some embodiments, a signal which resets the timing interval is caused when conditions indicative of a person being in the bathroom are detected.

In some embodiments, the method of the third aspect of the invention may be performed using the bathroom light system controller or bathroom light system of the present invention.

### BRIEF DESCRIPTION OF DRAWINGS

The present invention will be described in further detail below with reference to the following figures, in which:

FIG. 1 is a block diagram illustrating how a bathroom light system controller in accordance with an embodiment of the present invention operates;

FIG. 2 is a block diagram illustrating how a bathroom light system controller in accordance with an embodiment of the present invention having primary and secondary light sources operates; and

FIG. 3 is a schematic illustration of a specific embodiment of an electricity supply controller in accordance with the present invention.

### DESCRIPTION OF EMBODIMENTS

As noted above, the present invention provides a bathroom light system controller. The controller comprises a timer which is adapted to receive a signal that starts a timing interval, and an electricity supply controller which causes power supplied to a bathroom light system to be reduced when the timing interval ends, but which ensures that the bathroom light system still provides a source of light.

The present invention also provides a bathroom light system comprising this controller, as well as a method for reducing energy consumption by a bathroom light system. The method comprises starting a timing interval upon receipt of a signal and, when the timing interval finishes, reducing power to the bathroom light system but whilst ensuring that the bathroom light system still provides a source of light.

The present invention advantageously results in the power consumed by a bathroom light system being reduced after a defined timing interval, thereby saving power in the event that the light system (or components of the light system) has inadvertently been left on. In doing so, however, the controller ensures that the light system still provides some light so that, in the event that a user is still in the bathroom, they are not left completely in the dark at the end of the timing interval.

The amount of light provided after the electricity supply controller has reduced the power supplied to the bathroom light system will depend on the light system and its intended purpose. For example, the amount of light required to adequately illuminate a small bathroom (e.g. where a small LED light might provide sufficient light) at the end of the timing interval may be less than that required to illuminate a large bathroom (e.g. where a more substantial source of light may be required).

As will be appreciated, bathroom lighting systems can be somewhat unique, often having a number of separate components built in to the one system. For example, bathroom lighting systems may include any one or more of the following components: one or more heat lamps, one or more normal lights (e.g. incandescent, LED or compact fluorescent lights) and fans (or other kinds of ventilators such as dampers)). The present invention can be used with any bathroom lighting system having one or more lights (and optionally other components such as fans).

As used herein, the phrase “light system” is to be understood as referring to a system having one or more lights which provide illumination (and possibly other functions) to an area. All of the components of the lighting system may be present in one luminaire and controlled via one control unit, or the lighting system may be provided by a number of separate luminaires and/or control units.

It is envisaged that the present invention will primarily find use with bathroom light systems typically having one or more heat lamps (which draw a relatively large amount of power), a fan (which draws a moderate amount of power) and a normal light (which also draws only a moderate amount of power). The term “normal light”, as used herein, refers to a light which draws less power than other light sources, such as heat lamps, spotlights, etc., in the light system. Whether a light is a “normal light” is relative and will depend on the other sources of light in the same light system.

Typically, when a user exits the bathroom, they would turn off power to the bathroom light system. Such a positive action on behalf of the user would usually (but not necessarily always) completely turn off the bathroom light system and override its safety function. The present invention is primarily intended to operate in situations where the user forgets to turn off the power to the bathroom light system.

The bathroom light system controller of the present invention comprises a timer which is adapted to receive a signal that starts a timing interval. Similarly, the method of the present invention comprises starting a timing interval upon receipt of a signal.

Any timer capable of timing the timing interval and communicating with the electricity supply controller may be used. Typically, the timer would be incorporated into the electrical circuitry of the controller (and possibly provided in an integrated unit with the electricity supply controller), although remote timers which communicate with the electricity supply controller via electrical wiring or wireless technologies may also be used. The timer may be triggered by any appropriate signal, and may indicate the end of the timing interval using any appropriate means. For example, the timer may be triggered (so that the timing interval is started) when it detects the flow of electricity to the bathroom light system (or a specific component of the light system) or when it detects an electrical pulse. Alternatively, the timer may be triggered when it receives a signal at a predefined frequency. The timer may communicate the end of the timing interval to the electricity supply controller using similar means.

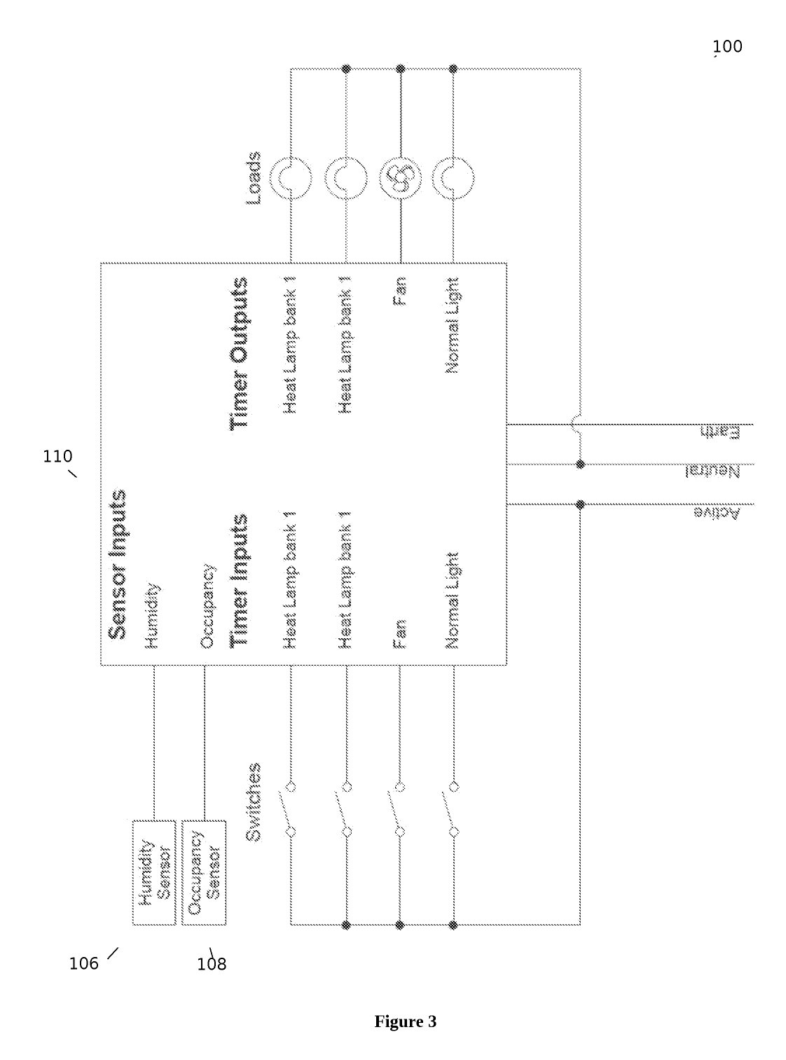

Suitable timers for use with the present invention include Powerform Controls ROTS timers, which are timers with four inputs and 4 outputs (discussed below in the context of FIG. 3). Alternatively, a PLC (programmable logic controller), such as a Siemens Logo! 230RC unit could be used (with appropriate programming).

The signal that starts the timing interval may be caused by any action which results in significant amounts of power being drawn by the bathroom light system. The amount of power drawn by the bathroom light system will vary depending on the light system and its intended purpose, and it is within the ability of a person skilled in the art to ascertain what constitutes a significant amount of power for a particular light system. The signal that starts the timing interval may, in some embodiments, be caused by the bathroom light system being switched on. For example, if the light system includes only one or two heat lamps, then it would be desirable that these heat lamps not be left on unnecessarily, and that the timer be activated immediately so that they are turned off/down at the end of the timing interval.

The signal that starts the timing interval may, in some embodiments, be caused by a component which draws a substantial portion of the total power required by the bathroom light system being switched on. Such embodiments would be more appropriate when the bathroom light system is of a kind that includes a number of different electrical components such as heat lamps, a fan and a normal light. In such circumstances, it may not be appropriate for the timing interval to be started when only the fan or normal light was turned on because their power consumption is relatively low. Thus, the timing interval in such an embodiment may only be started when the heat lamps (which draw much more power than the fan and normal light) in the bathroom light system are turned on.

Any timing interval may be selected, depending on the type and intended purpose of the bathroom light system. For example, timing intervals in the order of a few minutes may be appropriate for some bathroom users, but timing intervals in the order of tens of minutes more appropriate for other users (e.g. those who like to take long showers or have long baths). It is within the ability of a person skilled in the art to determine an appropriate timing interval for any given bathroom light system.

The timing interval may be fixed or may be selectively adjustable by a user (e.g. by providing a turnable knob proximal to the light switches, possibly with indicia indicative of the duration of the timing interval). As will be discussed in further detail below, it is also envisaged that signals may be received from other sources which cause the timing interval to be reset, either for the original timing interval or for a longer or shorter timing interval.

The present invention may also comprise multiple timing intervals, for example to provide for a staged power down of a light system. For example, turning on the heat lamps of a bathroom luminaire may activate a first timing interval where, at the end of the first timing interval, the heat lamps are turned off (with the normal light either remaining on or being turned on). However, a second timing interval may be used to turn off the normal light at the end of a second timing interval (i.e. to completely power down the light system). The second timing interval may be started at any time (e.g. when the heat lamps were turned on by the user or turned off by the controller), but would need to ensure that the normal light remained on for a sufficient period of time after the heat lamps were turned off so as not to potentially strand a person in the dark.

The bathroom light system controller of the present invention also comprises an electricity supply controller which causes power supplied to the bathroom light system to be reduced when the timing interval ends, whilst ensuring that the bathroom light system still provides some light. Similarly, the method of the present invention also comprises reducing power to the bathroom light system when the timing interval finishes, but whilst ensuring that the bathroom light system still provides a source of light.

Any electricity supply controller capable of controlling the power supplied to the bathroom light system may be used in the present invention. The electricity supply controller may be capable of controlling the amount of power supplied to the bathroom light system as a whole or, where appropriate, capable of controlling the amount of power supplied to individual components (or groups of components, for example all of the heat lamps) of the bathroom light system.

The electricity supply controller may control the power supplied to the bathroom light system using any technique. For example, the electricity supply controller may comprise electrical switches for switching the power supplied to the light system (or components of the light system) on and off. Alternatively (or in addition), the electricity supply controller may comprise means for increasing or reducing the amount of power supplied to the light system, or individual (or grouped) components of the light system.

The electricity supply controller may, for example, be capable of controlling the amount of power received by a component of the bathroom light system (typically a component which draws a substantial proportion of the total power required by the light system). Such an electricity supply controller may be useful for light systems having only high draw light sources (e.g. bathroom luminaires having only one or two heat lamps). At the end of the timing interval, the light system still provides some light because the reduced power flowing through the high draw light source(s) is enough to provide sufficient illumination to enable a person to safely navigate themselves out of the bathroom.

The electricity supply controller may, for example, be capable of reducing the amount of power supplied to certain bathroom light systems by turning off a primary light source of the light system (e.g. one or more heat lamps) and ensuring that a secondary light source of the light system (e.g. a normal light or only one of the heat lamps) is turned on or remains on. In order to do so, the electricity supply controller may comprise electrical switches for switching the primary light source and the secondary light source on and off. The electricity supply controller may also comprise voltage or current flow detectors for determining whether the secondary light source (and possibly the primary light source) is on or off. Alternatively, the electricity supply controller may simply switch the secondary light source on at the end of the timing interval, without checking its status beforehand.

In embodiments where the bathroom light system includes a fan, the electricity supply controller may also be adapted to turn the fan component of the light system off (or at least slow the fan down) when power supplied to the light system is caused to be reduced. As would be appreciated, a fan is not an important safety aspect of the bathroom light system, and turning it off would reduce power consumption.

As noted above, the electricity supply controller may be provided in an integrated unit with the timer, but this may not always be the case. Suitable electricity supply controllers for use with the present invention include Siemens PLC controllers such as the Siemens Logo! 230RC PLC controller (with a program written for it) discussed above.

In some embodiments, the bathroom light system controller of the present invention may include other components, and the method of the present invention include other steps. For example, as would be appreciated, the controller may, depending on the configuration of the controller, light switch and luminaire(s), include wiring, insulation, housing, means to receive wireless information, etc.

The bathroom light system controller may, for example, further comprise a detector adapted to provide a signal that resets the timing interval upon detection of conditions indicative of a person being in the bathroom. In some embodiments, the reset timing interval may be the same as that set originally (e.g. by a user turning on the light system or one of the components of the light system, as discussed above). In alternative embodiments, however, the reset timing interval may be shorter or (less commonly) longer than the original timing interval. In some embodiments, two timing intervals may operate simultaneously, with the light system powering down only when both timing intervals have ended. For example, when the heat lamps of a bathroom luminaire are first turned on, it may be appropriate to provide a reasonably long timing interval (e.g. 5 mins) before they will be turned off (and the normal light turned on) automatically. At the expiry of this time (or during this time), however, if a person is detected, the timing interval can be reset to, say, 2 mins. Thus, at the end of the 5 min period, if no person has been detected, then the heat lamps are turned off. However, if a person is detected, the heat lamps would stay on for another 2 mins after the person was detected, even if the initial 5 min period expired during this time. Further detection of a person would then continuously reset the timing interval and delay power down.

The detector may be physically located with the controller, the light system or elsewhere in the bathroom, provided that it can detect a person in an area illuminated by the light system. Any suitable detector may be used, and the detector can be incorporated into the present invention using conventional techniques (e.g. by being hard-wired into the controller). In some embodiments, the detector may be a discrete unit which communicates with the controller via any suitable wireless technology.

The detector may detect a person in the bathroom using any suitable means. For example, the detector may include a motion sensor or thermal camera adapted to provide a signal that resets the timing interval upon detection of motion or a thermal signature (e.g. a person's body heat).

The bathroom light system may also have a detector in the form of a humidity sensor for measuring the humidity in the bathroom. The humidity sensor may be physically located with the controller, the light system or elsewhere in the bathroom, provided that it can detect the humidity in an area illuminated by the light system. Any suitable humidity sensor may be used, and the sensor can be incorporated into the present invention using conventional techniques (e.g. by being hard wired into the controller). In some embodiments, the humidity sensor may be a discrete unit which communicates with the controller via any suitable wireless technology. The humidity sensor is adapted to provide a signal that resets the timing interval upon detection of humidity above a predetermined level.

In operation, the humidity sensor can provide a signal that resets the timing interval such that the fan component and/or heat lamps of the light system remain on until the humidity falls below a predetermined level (which can be set by a user). That is, once the bathroom light system is switched on, if the humidity in the vicinity of the sensor (and light system) is above a certain level, the timer will be continually reset, thereby delaying the controller reducing the power supplied to the light system. As will be appreciated, if the humidity in a bathroom is relatively high, this is indicative of a user having (or just completing) a shower or bath and, in such circumstances, it would be preferred that the heat lamps and fan be kept on at full power. In some embodiments, the reset timing interval is the same as the original timing interval (e.g. that started by switching the heat lamps on), but the reset timing interval could be longer or shorter in alternate embodiments. For example, if the humidity sensor has detected a recent increase in humidity, then it is likely that a user has just started a shower or a bath, so a longer timing interval may be appropriate. However, if the humidity has remained constant for a period of time, or is slowly decreasing, then it is likely that the user has finished their shower or bath and a shorter timing interval may be more appropriate.

Thus, the humidity sensor is operable to make the heat lamps (and/or the fan) stay on for longer if someone is in the shower (i.e. relatively high humidity) compared to the situation if someone uses the bathroom to simply brush their teeth and forgets to turn off the heat lamps/fan. The humidity sensor may also be utilised to keep the fans of the bathroom light system on (or turn them on) independently of the operation of the present invention in the event of high levels of humidity being detected. As would be appreciated, bathrooms are especially susceptible to the growth of mould, etc. and controlling the humidity in the bathroom is one of the ways in which the growth of mould can be controlled.

In apartment complexes, air is sometimes extracted from a bathroom via ducting that links the bathroom to a central duct which is maintained at a negative pressure. In some circumstances, the volume of air extracted from the apartment is controlled by dampers which are operable to effectively open and close the duct. The humidity sensor could therefore also be used to control the dampers such that they remain in an open state until such time as the humidity in the bathroom reaches the predetermined level.

The bathroom light system may also have a detector in the form of a water flow sensor for sensing whether water is flowing through a fixture in the bathroom (e.g. in a shower or bath). Whilst a flow of either hot or cold water could be detected, a flow of hot water would be more likely to be indicative of a person being in the bathroom for a longer time (e.g. not just brushing their teeth or washing their hands).

The bathroom light system may also have a detector in the form of a weight sensor for sensing whether a person is sitting on a toilet in the bathroom.

In some embodiments, the present invention may employ one or more detectors for detecting conditions indicative of a person being in the bathroom. The controller may be adapted to receive data from each of these detectors either individually or in combination.

In some embodiments, the light system may be permanently on but in a standby mode, where the lights are off but, upon detection of a person in the bathroom (e.g. via movement), the lights are switched on and the timing interval started.

As noted above, the present invention also provides a method for reducing energy or power consumption by a bathroom light system. The method comprises starting a timing interval upon receipt of a signal and, when the timing interval finishes, reducing power to the bathroom light system but whilst ensuring that the bathroom light system still provides some light.

In some embodiments, the signal that causes the timing interval to start may be generated by the bathroom light system being switched on. In some embodiments, the signal may be caused by a component which draws a substantial portion of the total power required by the bathroom light system (e.g. heat lamps) being switched on.

In some embodiments, power to the bathroom light system may be reduced by turning down or off a component of the bathroom light system which draws a substantial portion of the total power required by the bathroom light system (whilst ensuring that at least some light is still provided by the bathroom by the lighting system). For example, in embodiments where the bathroom light system has primary and secondary light sources, power to the bathroom light system may be reduced by turning off the primary light source, whilst ensuring that the secondary light source is turned on, either immediately before, at the same time or immediately after the primary light source is turned off.

Ensuring that the secondary light source is turned on may be carried out using any suitable technique, for example, by monitoring the voltage across or current flow through the secondary light source to see whether it is turned on and, if not, turning it on. Alternatively, such monitoring need not be carried out and the secondary light source simply be turned on by the controller, regardless of its current state.

In some embodiments, a signal which resets the timing interval is caused (e.g. by a detector such as a motion sensor or thermal camera) to be generated when conditions indicative of a person being in the bathroom are detected. In some embodiments, the reset timing interval may be shorter than the timing interval. In some embodiments, the reset timing interval may be longer than the timing interval.

Specific embodiments of the bathroom light system controller, bathroom light system and method for reducing energy or power consumption in accordance with the present invention will now be described.

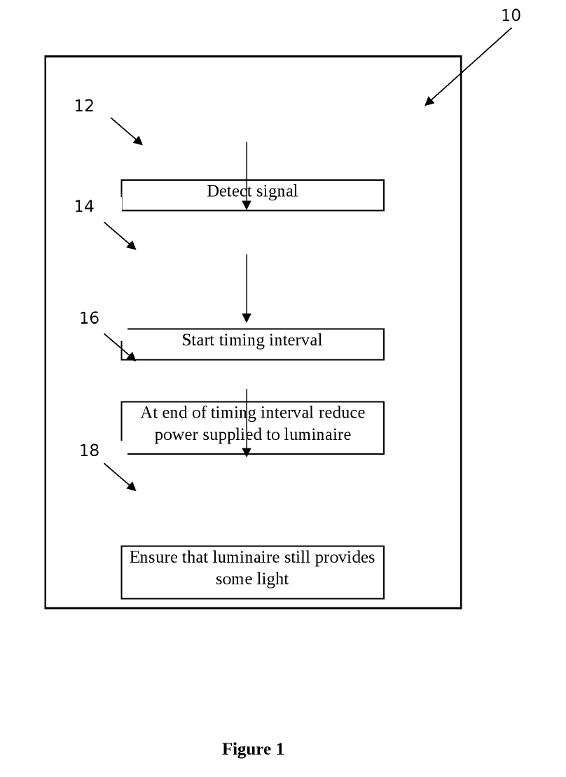

Referring now to FIG. 1, shown is a block diagram illustrating how a bathroom light system controller in accordance with an embodiment of the present invention operates.

A controller for a bathroom light system 10 has a timer which is adapted to detect a signal 12 that starts a timing interval 14. Controller 10 also has an electricity supply controller 16 which reduces power supplied to a luminaire in the bathroom light system when the timing interval ends, but whilst ensuring 18 that a luminaire in the bathroom light system still provides some light.

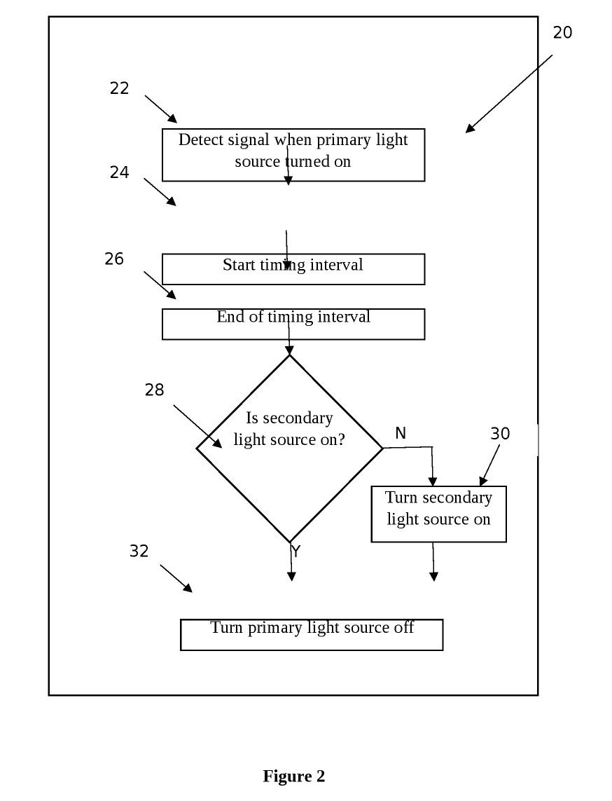

Referring now to FIG. 2, shown is a block diagram illustrating how a specific embodiment of a bathroom light system controller in accordance with the present invention having primary and secondary light sources operates.

In this embodiment, a controller for a bathroom luminaire 20 has a timer which is adapted to detect a signal 22 when the primary light source (e.g. one or more heat lamps) of the luminaire is turned on. The signal starts a timing interval 24 and, at the end of the timing interval 26, an electricity supply controller checks 28 to see whether a secondary light source (e.g. a normal light or only one of the heat lamps) is on or not (e.g. by monitoring the current flowing through the secondary light source). If the secondary light source is not on, the electricity supply controller turns it on 30, after which the power supplied to the luminaire is reduced by the electricity supply controller turning off the primary light source 32. If the secondary light source is already on, then the electricity supply controller simply turns off the primary light source 32.

Referring now to FIG. 3, shown is a schematic illustration of a specific embodiment of a light system 100 in accordance with the present invention. The light system 100 has an electricity supply controller 102 and a power source 104. The light system 100 also includes sensors for monitoring the humidity 106 in the bathroom and whether the bathroom is occupied 108. The humidity and occupancy sensors 106, 108 are capable of transmitting a signal to sensor inputs 110 of the controller 102 upon detection of a condition (e.g. humidity above a certain level for the humidity sensor 106 and movement for the occupancy sensor 108). These signals are processable by the controller 102 to reset the timing interval in appropriate circumstances (e.g. as discussed above). The humidity and occupancy sensors 106, 108 may continually transit signals to the sensor inputs 110, or may transmit signals at periodic intervals in order to conserve power.

The controller 102 also includes timer inputs 112 for receiving signals that cause the respective component of the light system 100 to be switched on, and which may cause the timing interval to start. The timer inputs 112 include inputs for two banks of heat lamps—bank one 114, which includes one or more heat lamps 116 and bank two 118, which includes the remaining heat lamps 120 (unless one of those heat lamps is the “normal” light in the system, as discussed below). Typically, the number of heat lamps in each bank 116, 120 will either be the same (for light systems with an even number of heat lamps) or differ by one (for light systems with an odd number of heat lamps), although this may not be the case for light systems that do not include a normal light and where the “normal light” is provided by one of the heat lamps. The controller 102 also includes timer inputs 122 and 124 for the fan 126 and the normal light 128, respectively.

Controller 102 is therefore able to cause the timing interval to be started upon input from any of the sensor inputs 110 (i.e. upon detection of humidity or a person in the bathroom) and timing inputs 112 (i.e. upon a user switching on the heat lamp(s), fan or normal light). As discussed above, typically, the timing interval will only be started when one of the high draw components (e.g. the heat lamps 116 and/or 120) are turned on.

The controller 102 has timer outputs 130, 132, 134 and 136 which, at the end of the timing interval(s), turn off the respective component(s) (i.e. heat lamps 116 and 120, fan 126 and normal light 128, respectively). Controller 102 is therefore also able to turn off any one or more of the components of the light system at the end of the timing interval and, where multiple timing intervals are provided, power down the light system 100 in a staged manner (e.g. heat lamps 116 and 120 turned off after 5 mins, fan turned off after 10 mins and the normal light turned off after 15 mins—but only provided there is no risk of a person being in the bathroom at this time; it may be safer to leave the normal light on indefinitely until appositive action on the behalf of the user is made to switch the system completely off). The timing interval may be reset (as discussed above) upon the controller 102 receiving a signal from either of the sensors 106, 108.

In some embodiments (not shown), one or more of the components of the light system may be outside of the system—i.e. not wired through the controller.

In a further specific embodiment, the light system is for use in a bathroom of an apartment and has three heat lamps, a fan and a normal light. The heat lamps and light are controlled via separate switches, and the fan may come on automatically when the normal light is turned on, or manually via its own switch. The heat lamp and light switches are wired to a control unit's inputs, and the heat lamp and at least one room light (typically the normal light, but it could be one of the heat lamps) are wired to the control unit's outputs. The fan may be wired directly to the switch (for independent operation) or via the control unit's output (if it is also to be controlled by the controller of the present invention).

In cases where the luminaire has more than one normal light, then only one of those lights would usually be wired into the control unit. This reduces the power consumption because only one light would be turned on by the control unit when the heat lamps are turned off. Furthermore, should the control unit fail for some reason, then the room would not be left in darkness. The other of the normal lights would typically be operated independently of the control unit.

The primary aim of the control unit is to turn off the heat lamps if they are inadvertently left on. However, in doing so, it is important to make the bathroom safe so that any occupant is not left in darkness because most apartment bathrooms don't have any natural light.

In operation of this specific embodiment, when the heat lamps are turned on, a timer is started and, after a pre-set time, the heat lamps are automatically turned off (the fan may also be turned off at this time if desired). When the heat lamps are turned off, if the normal light is on, then nothing special happens but, if the normal light is off, then it is turned on.

In minor variations of this embodiment:
the heater lamps may be dimmed instead of turning them immediately off;
the heater lamps may be dimmed for another period and then turned off completely;
the fan may be slowed down instead of turning it immediately off; and
the fan may be slowed down for another period and then turned off completely; and
an occupant sensor may be used to keep the heat lamps on but, after nobody is detected for a predetermined period of time, the heat lamps are turned off and just a single light is left on.

In all embodiments, it may be desirable at times to bypass the control unit (i.e. to have the bathroom light system operate in a more traditional manner). In such embodiments, the control unit may be adapted to recognise a signal which makes it inactive. For example, a quick on/off sequence by a switch (e.g. the normal light switch) could be used to bypass the control unit and associated timer for turning off the heat lamp or fan. A second such on/off sequence could be used to reactivate the control unit.

It will be appreciated that the present invention provides a number of new and useful results. For example, specific embodiments of the present invention may provide one or more of the following advantages:
power savings, but not at the cost of safety;
increasing the lifespan of bathroom light system components;
lessening fire risk due to overheating of the area surrounding heat lamps; and
readily adaptable for use with many different kinds of bathroom light systems.

It will be understood to persons skilled in the art of the invention that many modifications may be made without departing from the spirit and scope of the invention. All such modifications are intended to fall within the scope of the following claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A bathroom light system controller, the controller comprising:
a timer which is adapted to receive a signal that starts a timing interval; and
an electricity supply controller which causes power supplied to a bathroom light system to be reduced when the timing interval ends, but which ensures that the bathroom light system still provides a source of light.

2. The bathroom light system controller as claimed in claim 1, wherein the electricity supply controller is adapted to control the amount of power received by a component of the bathroom light system.

3. The bathroom light system controller as claimed in claim 2, wherein the component of the bathroom light system is a component which draws a substantial proportion of the total power required by the bathroom light system.

4. The bathroom light system controller as claimed in claim 1, wherein the electricity supply controller is adapted to turn off a primary light source of the bathroom light system and ensure that a secondary light source of the bathroom light system is turned on.

5. The bathroom light system controller as claimed in claim 4, wherein the primary light source of the bathroom light system is one or more heat lamps.

6. The bathroom light system controller as claimed in claim 4, wherein the electricity supply controller comprises electrical switches for switching the primary light source and the secondary light source on and off.

7. The bathroom light system controller as claimed in claim 4, wherein the electricity supply controller comprises a current flow detector for determining whether the secondary light source is on or off.

8. The bathroom light system controller as claimed in claim 1, wherein the signal that starts the timing interval is caused by the bathroom light system being switched on.

9. The bathroom light system controller as claimed in claim 1, wherein the signal that starts the timing interval is caused by a component which draws a substantial proportion of the total power required by the bathroom light system being switched on.

10. The bathroom light system controller as claimed in claim 1, wherein the timing interval is selectable by a user.

11. The bathroom light system controller as claimed in claim 1, further comprising a detector adapted to provide a signal that resets the timing interval upon detection of conditions indicative of a person being in the bathroom.

12. The bathroom light system controller as claimed in claim 1, wherein the electricity supply controller is adapted to turn a fan component of the bathroom light system off when power supplied to the bathroom light system is reduced.

13. A bathroom light system comprising the bathroom light system controller as claimed in claim 1.

14. A method for reducing energy consumption by a bathroom light system, the method comprising:
starting a timing interval upon receipt of a signal; and
reducing power to the bathroom light system when the timing interval finishes, but whilst ensuring that the bathroom light system still provides a source of light.

15. The method of claim 14, wherein the signal is caused by the bathroom light system being switched on.

16. The method of claim 14, wherein the signal is caused by a component which draws a substantial proportion of the total power required by the bathroom light system being switched on.

17. (canceled)

18. The method of claim 14, wherein power to the bathroom light system is reduced by reducing the power supplied to a component of the bathroom light system which draws a substantial proportion of the total power required by the bathroom light system.

19. The method of claim 14, wherein power to the bathroom light system is reduced by turning off a primary light source of the bathroom light system and ensuring that a secondary light source of the bathroom light system is turned on.

20. The method of claim 18, wherein ensuring that the secondary light source of the bathroom light system is turned on comprises determining whether the secondary light source is turned on and, if not, turning it on.

21. (canceled)

22. The method of claim 14, wherein a signal which resets the timing interval is caused when conditions indicative of a person being in the bathroom are detected.
